(19) United States
(12) Patent Application Publication
(10) Pub. No.: US 2025/0353724 A1
(43) Pub. Date: Nov. 20, 2025

(54) WATER DISPENSER

(71) Applicants: FOSHAN SHUNDE MIDEA WATER DISPENSER MANUFACTURING CO., LTD., Foshan (CN); MIDEA GROUP CO., LTD., Foshan (CN)

(72) Inventors: Sipei HONG, Foshan (CN); Baoyou CHENG, Foshan (CN)

(73) Assignees: FOSHAN SHUNDE MIDEA WATER DISPENSER MANUFACTURING CO., LTD., Foshan (CN); MIDEA GROUP CO., LTD., Foshan (CN)

(21) Appl. No.: 18/999,548

(22) Filed: Dec. 23, 2024

Related U.S. Application Data
(63) Continuation of application No. PCT/CN2024/133002, filed on Nov. 19, 2024.

(30) Foreign Application Priority Data
May 15, 2024 (CN) 202410607623.9
May 15, 2024 (CN) 202421065411.4
May 15, 2024 (CN) 202421065516.X

(51) Int. Cl. B67D 1/00; B67D 1/08

(52) U.S. Cl. CPC B67D 1/0014; B67D 1/0858; B67D 1/0895; B67D 2210/00034; B67D 2210/00118

(57) ABSTRACT

Provided is a water dispenser. The water dispenser includes a housing and a functional module. The functional module is disposed in the housing. The functional module includes a mounting support, a heating tank component, a cooling tank component, a water manifold component, and an electronic control component, and the heating tank component, the cooling tank component, the water manifold component, and an electronic control component are disposed at the mounting support. The heating tank component, the cooling tank component, the water manifold component, and the electronic control component are all integrated into the functional module through the mounting support.

### CROSS-REFERENCE TO RELATED APPLICATIONS

This application is a continuation of International Application No. PCT/CN2024/133002, filed on Nov. 19, 2024, which is based on and claims priority to Chinese Patent Application No. 202410607623.9 titled “WATER DISPENSER” and filed on May 15, 2024, Chinese Patent Application No. 202421065411.4 titled “WATER DISPENSER” and filed on May 15, 2024, and Chinese Patent Application No. 202421065516.X titled “WATER DISPENSER” and filed on May 15, 2024, the entire contents of each of which are incorporated herein by reference. No new matter has been introduced.

### FIELD

The present disclosure relates to the field of drinking water device technologies, and more particularly, to a water dispenser.

### BACKGROUND

With the continuous development of water dispenser industry, water dispensers have increased functions. For example, the water dispensers are already equipped with the functions of providing room temperature water, hot water, and cold water. However, in the related art, since the water dispenser has a large number of parts and components, for example, typically including a hot tank, a cold tank, a water tube, a water manifold, etc., a sequential mounting of the parts and components to the housing requires numerous steps, resulting in complex assembling operations of the water dispenser that would directly affect assembling efficiency of the water dispenser. Therefore, there is room for improvement.

### SUMMARY

Embodiments of the present disclosure provide a water dispenser.

A water dispenser according to embodiments of the present disclosure includes a housing and a functional module. The functional module is disposed in the housing. The functional module includes a mounting support, a heating tank component, a cooling tank component, a water manifold component, and an electronic control component, and the heating tank component, the cooling tank component, the water manifold component, and the electronic control component are disposed at the mounting support.

Embodiments of the present disclosure also provide a water dispenser.

A water dispenser according to embodiments of the present disclosure includes a housing, a water outlet device, and a tap. The housing has a front opening and includes a front cover plate. The front cover plate is detachably disposed at the front opening to cover the front opening. The water outlet device is at least partially disposed in the housing and faces towards the front opening. Further, the water outlet device has a water supply opening and a guide post provided at an upper surface of the water outlet device. The guide post extends in an up-down direction. The front cover plate has an avoidance opening and a guide hole. The avoidance opening faces towards the water supply opening and in communication with the water supply opening, and the guide post is engaged into the guide hole. A part of the tap is located at a front side of the front cover plate. Further, the part of the tap extends into the avoidance opening to be connected to the water supply opening.

Additional aspects and advantages of the embodiments of present disclosure will be provided at least in part in the following description, or will become apparent in part from the following description, or can be learned from the practice of the embodiments of the present disclosure.

### BRIEF DESCRIPTION OF THE DRAWINGS

FIG. 1 is a schematic view of a water dispenser according to an embodiment of the present disclosure.

FIG. 2 is an exploded view of the water dispenser in FIG. 1.

FIG. 3 is another schematic view of the water dispenser according to an embodiment of the present disclosure.

FIG. 4 is a schematic front view of a support frame and a functional module of a water dispenser according to an embodiment of the present disclosure.

FIG. 5 is a schematic rear view of a support frame and a functional module of a water dispenser according to an embodiment of the present disclosure.

FIG. 6 is an enlarged view of region A in FIG. 4.

FIG. 7 is an enlarged view of region B in FIG. 5.

FIG. 8 is an exploded view of a support frame and a functional module of a water dispenser according to an embodiment of the present disclosure.

FIG. 9 is a schematic partial view of a functional module of a water dispenser according to an embodiment of the present disclosure.

FIG. 10 is an exploded view of a functional module of a water dispenser according to an embodiment of the present disclosure.

FIG. 11 is an exploded view of a water dispenser according to another embodiment of the present disclosure.

FIG. 12 is an exploded view of a water dispenser according to yet another embodiment of the present disclosure.

FIG. 13 is a partial exploded view of a water dispenser according to an embodiment of the present disclosure.

FIG. 14 is another partial exploded view of the water dispenser according to an embodiment of the present disclosure.

FIG. 15 is a perspective view of a side plate of a water dispenser according to an embodiment of the present disclosure.

FIG. 16 is a perspective view of a front cover plate of a water dispenser according to an embodiment of the present disclosure.

FIG. 17 is a cross-sectional view of a water dispenser according to an embodiment of the present disclosure.

### REFERENCE NUMERALS LIST

Water dispenser 100;
housing 1; mounting chamber 10a; mounting opening 10b; receiving chamber 10c; front opening 10d; base 11; side plate 12; first positioning structure 121; body 122; flange 123; connection hole 124; positioning hole 125; upper cover 13; front cover component 14; front cover plate 141; avoidance opening 1411; guide hole 1412; guide plate 1413; connection hook 1414; tap 142; water receiving box 143; back plate 15; door 16; intelligent seat 17; partition 18;
functional module 2; mounting support 21; second positioning structure 211; bottom plate 212; support side plate 213; assembling hole 214; heating tank component 22; hot tank 221; three-way tube 222; cooling tank component 23; cold tank 231; condenser 232; compressor 233; water manifold component 24; first water manifold 241; second water manifold 242; water outlet device 243; water supply opening 2431; guide post 2432; fixing cover 244; seal 245; electric control box 251; electric control switch 252.

### DETAILED DESCRIPTION OF THE EMBODIMENTS

The embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the accompanying drawings are illustrative only, and are intended to explain rather than limiting the present disclosure.

Various embodiments or examples for implementing different structures of the embodiments of the present disclosure are provided below. To simplify the present disclosure, components and settings in specific examples are described below. Of course, they are merely exemplary and are not intended to limit the present disclosure. Moreover, the present disclosure may repeat reference numbers and/or reference letters in different examples. Such repetition is for purposes of simplicity and clarity and is in itself indicative of a relationship among the various embodiments and/or settings discussed. In addition, the present disclosure provides examples of various specific processes and materials, but those ordinary skilled in the art may recognize application of other processes and/or use of other materials.

A water dispenser 100 according to embodiments of the present disclosure will be described below with reference to the accompanying drawings.

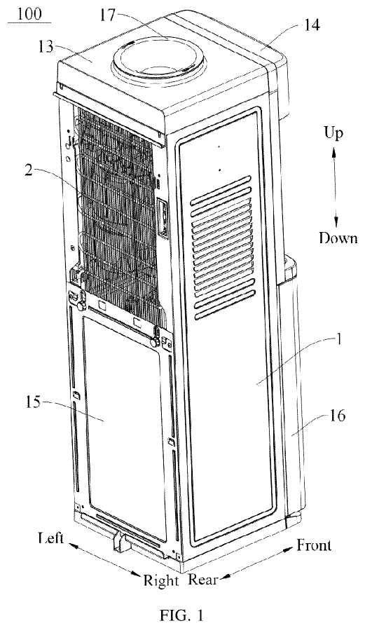

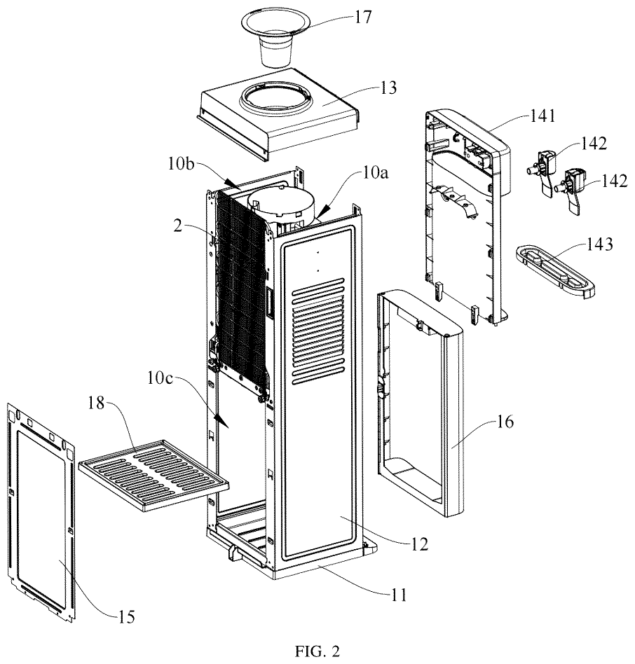

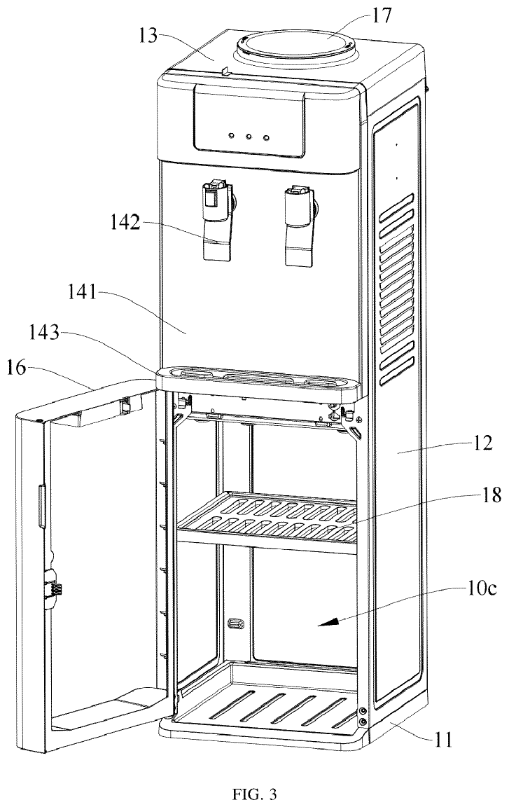

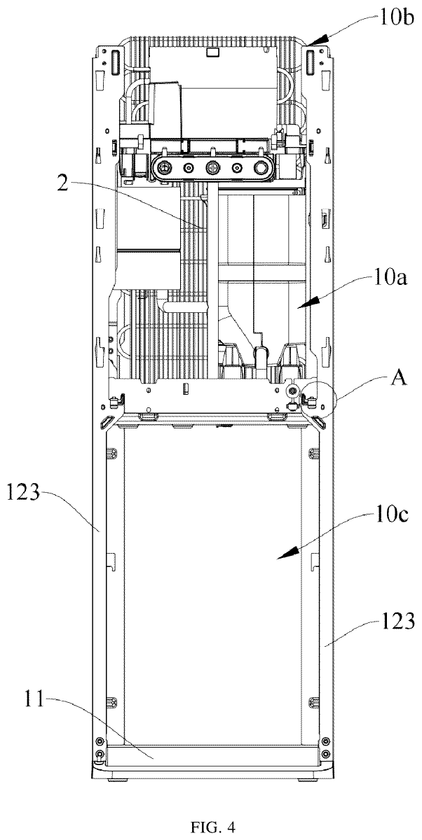

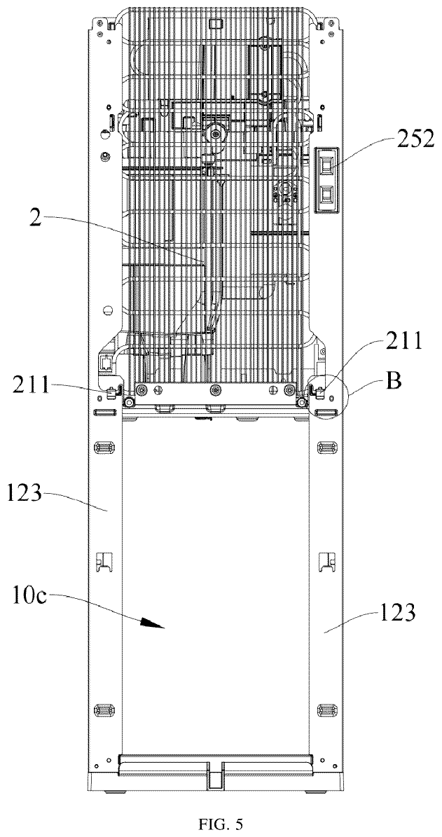

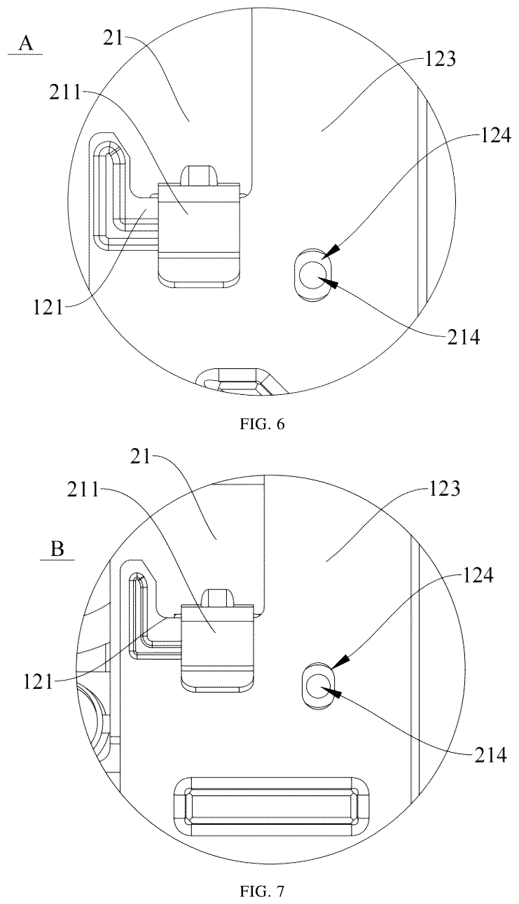

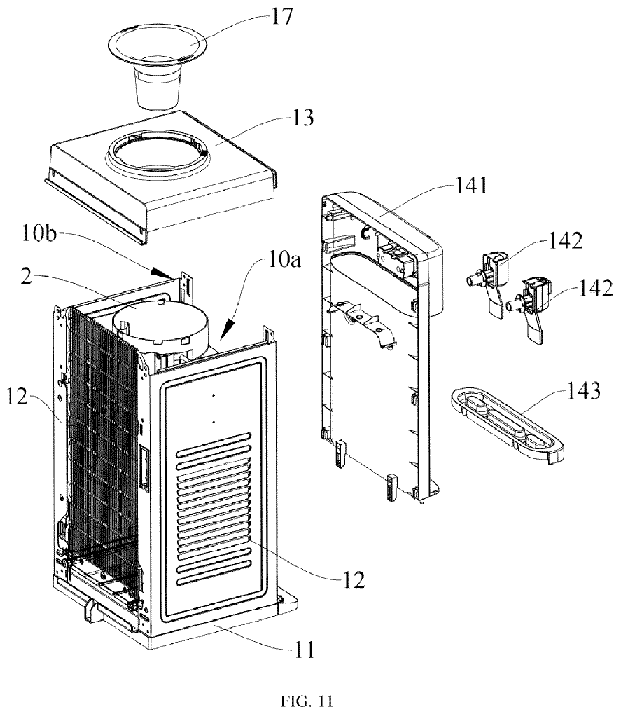

As shown in FIGS. 1 to 12, the water dispenser 100 according to the embodiments of the present disclosure includes a housing 1 and a functional module 2. The functional module 2 is disposed in the housing 1. The functional module 2 includes a mounting support 21, a heating tank component 22, a cooling tank component 23, a water manifold component 24, and an electronic control component, and the heating tank component 22, the cooling tank component 23, the water manifold component 24, and the electronic control component are disposed at the mounting support 21. The heating tank component 22 is configured to output hot water. The cooling tank component 23 is configured to output cold water. The water manifold component 24 is configured to bring a water passageway inside the water dispenser 100 into communication with the heating tank component 22 and the cooling tank component 23 for example. The electronic control component is configured to control an operation state of each of the heating tank component 22 and the cooling tank component 23. The heating tank component 22, the cooling tank component 23, the water manifold component 24, and the electronic control component are all integrated into the functional module 2 by means of the mounting support 21 by arranging the heating tank component 22, the cooling tank component 23, the water manifold component 24, and the electronic control component at the mounting support 21. In this way, integration of the functional module 2 can better improved. In addition, since the functional module 2 is formed into one piece, it is only necessary to place the functional module 2 as a whole into the housing 1 and fix the functional module 2 during assembling of the water dispenser 100. Therefore, steps for mounting a plurality of functional components of the functional module 2 into the housing 1 separately is eliminated Therefore, the integration of the functional module 2 can be better improved while reducing assembling operations of the water dispenser 100 better. Therefore, assembling efficiency of the water dispenser 100 is improved.

In the water dispenser 100 according to the embodiments of the present disclosure, the heating tank component 22, the cooling tank component 23, the water manifold component 24, and the electronic control component are all integrated into the functional module 2 by means of the mounting support 21. As a result, the integration of the functional module 2 can be better improved. In addition, during the assembling of the water dispenser 100, it is only necessary to place the functional module 2 as a whole into the housing 1 and fix the functional module 2. Therefore, the assembling operations of the water dispenser 100 can better reduced. Therefore, the assembling efficiency of the water dispenser 100 is improved.

According to some embodiments of the present disclosure, the mounting support 21 is detachably connected to the housing 1. Thus, difficulty and cost of later maintenance of the functional module 2 and the housing 1 can be better reduced. For example, the functional module 2 may be detached from the housing 1 for overhauling, or only the housing 1 may be replaced when the housing 1 is damaged.

According to some embodiments of the present disclosure, the housing 1 has a mounting chamber 10a for containing the functional module 2. The mounting chamber 10a has a mounting opening 10b opening upwards, and the functional module 2 is adapted to be placed in the mounting chamber 10a through the mounting opening 10b. In some embodiments, the mounting chamber 10a is in communication with an external space via the mounting opening 10b, and the functional module 2 is placed into the mounting chamber 10a from top to bottom through the mounting opening 10b. Thus, difficulty in placing the functional module 2 into the mounting chamber 10a can be reduced due to the mounting opening 10b. As a result, it is beneficial to improving the assembling efficiency of the functional module 2 and the housing 1.

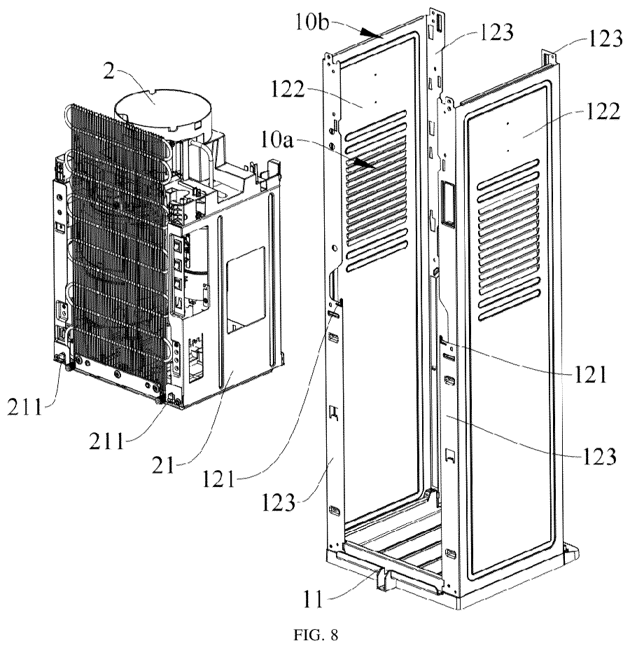

According to some embodiments of the present disclosure, as shown in FIG. 8, the housing 1 includes a support frame, and the functional module 2 is disposed at the support frame. The support frame includes a base 11 and two side plates 12 opposite to each other and spaced apart from each other in a left-right direction. The base 11 is located at a lower side of the mounting chamber 10a. The two side plates 12 are located at a left side and a right side of the mounting chamber 10a, respectively, and lower ends of the two side plates 12 are connected to the base 11. The mounting opening 10 is defined between upper ends of the two side plates 12. The support frame has an assembled state in which a distance between the two side plates 12 increases from bottom to top.

In some embodiments, when the support frame is in the assembled state, the lower ends of the left side plate 12 and the right side plate 12 are connected to each other by the base 11. Therefore, a relative position between the left side plate 12 and the right side plate 12 can be better maintained by the base 11 to improve structural stability of the support frame. The functional module 2 is placed in the mounting chamber 10a through the mounting opening 10b between the upper end of the left side plate 12 and the upper end of the right side plate 12. A distance between the upper end of the left side plate 12 and the upper end of the right side plate 12 is greater than a distance between the lower end of the left side plate 12 and the lower end of the right side plate 12, and thus a mounting passage for the functional module 2 that gradually widens from bottom to top is formed. Therefore, the difficulty in placing the functional module 2 between the left side plate 12 and the right side plate 12 from top to bottom can be reduced. In this way, it is beneficial to improving assembling efficiency of the functional module 2 and the support frame.

In an exemplary example, the support frame further has a completely assembled state in which the functional module 2 has been placed in the mounting chamber 10a and connected to the support frame, and a distance between the left side plate 12 and the right side plate 12 in an up-down direction is constant. In the assembled state, the left side plate 12 and the right side plate 12 obliquely extend away from each other from bottom to top. In some embodiments, the left side plate 12 is inclined away from the right side plate 12, and the right side plate 12 is inclined away from the left side plate 12, to increase the distance between the upper end of the left side plate 12 and the upper end of the right side plate 12. Therefore, the functional module 2 can be easily placed between the two side plates 12.

It should be noted that the relative position relationship between the left side plate 12 and the right side plate 12 in the assembled state can be achieved by a swing mechanism. For example, the lower end of the left side plate 12 and the lower end of the right side plate 12 are connected to the base 11 by respective swing mechanisms. The left side plate 12 may swing away from the right side plate 12 relative to the base 11 by a corresponding swing mechanism, and the right side plate 12 may swing away from the left side plate 12 relative to the base 11 by a corresponding swing mechanism. In this way, it can be ensured that in the assembled state the distance between the left side plate 12 and the right side plate 12 gradually increases from bottom to top. In some other embodiments, a pushing force may be directly applied to the upper end of the left side plate 12 and the upper end of the right side plate 12 to move the upper end of the left side plate 12 and the upper end of the right side plate 12 away from each other. In this cay, a slight elastic deformation is generated on the left side plate 12 and the right side plate 12, to ensure that in the assembled state the distance between the left side plate 12 and the right side plate 12 gradually increases from bottom to top. The manner of switching the left side plate 12 and the right side plate 12 into the assembled state is not specifically limited herein.

According to some embodiments of the present disclosure, in the assembled state, an angle of the two side plates 12 relative to an up-down direction ranges from 10° to 20°. In some embodiments, in the assembled state, an inclination angle of the side plate 12 relative to the up-down direction is controlled within the range of 10° to 20°. For example, in the assembled state, the inclination angle of the side plate 12 relative to the up-down direction may be 10°, 11°, 12°, 13°, 14°, 15°, 16°, 17°, 18°, 19°, 20°, etc. The side plate 12 is not specifically limited to these examples. In the assembled state, the distance between the upper end of the left side plate 12 and the upper end of the right side plate 12 increases as the inclination angle of the side plate 12 relative to the up-down direction increases. In this case, it is less difficult to place the functional module 2 between the two side plates 12. However, the deformation or swing amplitude of the left side plate 12 and the right side plate 12 increases at the same time. Conversely, in the assembled state, the deformation or the swing amplitude of the left side plate 12 and the right side plate 12 decreases as the inclination angle of the side plate 12 relative to the up-down direction decreases. However, the distance between the upper end of the left side plate 12 and the upper end of the right side plate 12 decreases at the same time, and it is more difficult to place the functional module 2 between the two side plates 12. Thus, by controlling the inclination angle of the side plate 12 relative to the up-down direction to range from 10° to 20° in the assembled state, the difficulty in placing the functional module 2 between the two side plates 12 can be reduced while reducing the requirements for the deformation or the swing amplitude of the left side plate 12 and the right side plate 12.

According to some embodiments of the present disclosure, a first positioning structure 121 is formed at the housing 1, and a second positioning structure 211 is formed at the mounting support 21. The first positioning structure 121 is engaged with the second positioning structure 211 when placing the functional module 2 into the mounting chamber 10a from top to bottom to limit a position of the functional module 2. In addition, the first positioning structure 121 is disengaged from the second positioning structure 211 when moving functional module 2 relative to the housing 1 from bottom to top. In some embodiments, during the mounting of the functional module 2 into the housing 1, the first positioning structure 121 moves towards the second positioning structure 211 and gradually engages with the second positioning structure 211. After the first positioning structure 121 and the second positioning structure 211 are fully engaged with each other, the functional module 2 is mounted in place. In some embodiments, the mounting position of the functional module 2 in the housing 1 can be better positioned through the engagement of the first positioning structure 121 and the second positioning structure 211. Therefore, difficulty in positioning the functional module 2 can be reduced when the functional module 2 is mounted in the housing 1. Meanwhile, mounting position accuracy of the functional module 2 in the housing 1 can be improved. When the functional module 2 is detached from the housing 1 from bottom to top, the first positioning structure 121 is gradually disengaged from the second positioning structure 211. In some embodiments, the first positioning structure 121 and the second positioning structure 211 may automatically release the engagement during the detachment of the functional module 2 without releasing the engagement between the first positioning structure 121 and the second positioning structure 211 separately. In this way, the disassembling operations are simplified.

According to some embodiments of the present disclosure, one of the first positioning structure 121 and the second positioning structure 211 is formed as a hooking slot, and another one of the first positioning structure 121 and the second positioning structure 211 is formed as a hook. The first positioning structure 121 may be formed as a hooking slot, and the second positioning structure 211 may be formed as a hook; or the first positioning structure 121 may be formed as a hook, and the second positioning structure 211 may be formed as a hooking slot, which are not specifically limited herein. In some embodiments, the mounting support 21 and the housing 1 are positioned through engagement of the hook and the hooking slot. An engagement mode of the hook and the hooking slot is simple. For example, the hook may be aligned with the hooking slot and engaged into the hooking slot during the engagement, and the hook may be taken out of the hooking slot when separation is required. Thus, difficulty in the engagement between the first positioning structure 121 and the second positioning structure 211 can be better reduced, which is beneficial to improving assembling efficiency of the functional module 2 and the housing 1.

In an exemplary embodiment of the present disclosure, the first positioning structure 121 is a hooking slot, and the second positioning structure 211 is a hook with an opening opening downwards. Therefore, when placing the functional module 2 into the mounting chamber 10a from top to bottom, the hook moves towards the hooking slot, and finally the hook is hooked at a bottom edge of the hooking slot to support the hook upwards. Thus, the housing 1 supports the functional module 2 upwards to hold the position of the functional module 2 in the up-down direction. When the functional module 2 needs to be taken out of the mounting chamber 10a, the functional module 2 is directly pushed and moves upwards, and the hook moves upwards synchronously to be disengaged from the hooking slot.

According to some embodiments of the present disclosure, the first positioning structure 121 and the second positioning structure 211 are arranged adjacent to a bottom of the mounting support 21. The bottom of the mounting support 21 herein refers to a position of the bottom of the mounting support 21 when the functional module 2 is mounted in place. In some embodiments, the first positioning structure 121 is engaged with the second positioning structure 211 when the functional module 2 moves from top to bottom until the functional module 2 is located near a final mounting position.

According to some embodiments of the present disclosure, the housing 1 includes two side plates 12 opposite to each other in a left-right direction. The two side plates 12 are located at two opposite sides of the mounting chamber 10a, respectively. Each of the two side plates 12 includes a body 122 and two flanges 123 respectively disposed at a front end and a rear end of the body 122. The mounting support 21 is located between the two flanges 123 of the two side plates 12. The two flanges 123 of one of the two side plates 12 are bent and extend towards the two flanges 123 of another one of the two side plates 12. The first positioning structure 121 is disposed at each of the two flanges 123.

In some embodiments, the mounting support 21 is positioned at the side plates 12 through the engagement of the first positioning structure 121 and the second positioning structure 211, and each flange 123 may be engaged with the corresponding second positioning structure 211 of the mounting support 21 by means of the corresponding first positioning structure 121. In this way, a positioning position for the mounting support 21 and the side plate 12 can be better increased. In this way, it is beneficial to improving positioning accuracy of the functional module 2 in the housing 1.

Moreover, since the mounting support 21 is located between the bodies 122 at two sides, freedom of a movement of the mounting support 21 in the left-right direction can be better limited by the bodies 122 at the two sides, and freedom of a movement of the mounting support 21 in a front-rear direction can be better limited by the two flanges 123 of each side plate 12. In this way, it is beneficial to improving stability of the connection between the functional module 2 and the housing 1. Meanwhile, the functional module 2 can be better protected by the bodies 122 at the left side and the right side, and the first positioning structure 121 is arranged at the flange 123, which can avoid the first positioning structure 121 of a hole or groove shape from damaging integrity of the body 122.

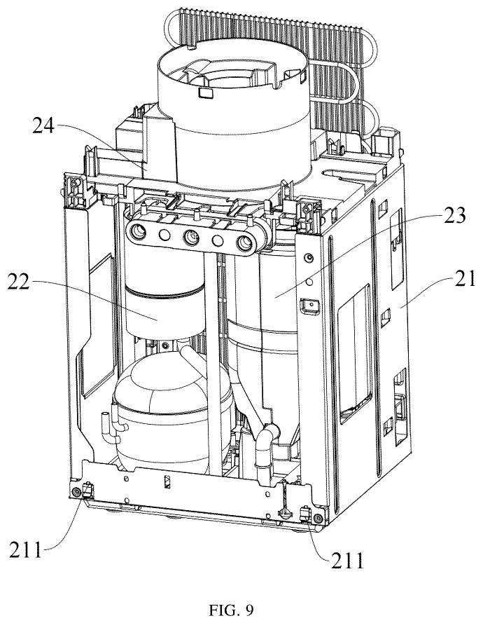

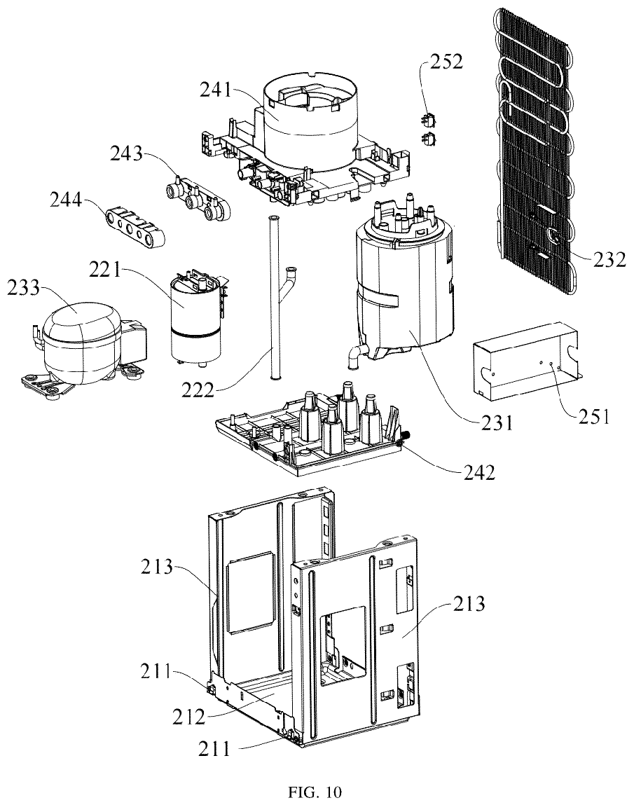

According to some embodiments of the present disclosure, as shown in FIGS. 9 and 10, the mounting support 21 includes a bottom plate 212 and two support side plates 213 disposed at a left side and a right side of the bottom plate 212, respectively. Each of the two support side plates 213 is located between two flanges 123 at a same side as the support side plate 213, and the second positioning structure 211 is disposed at each of front sides and rear sides of the two support side plates 213. In some embodiments, the support side plates 213 are engaged with and positioned to the side plates 12 through the engagement between the first positioning structure 121 and the second positioning structure 211. Therefore, the mounting support 21 can be engaged with and positioned to the housing 1 through the engagement and positioning between the support side plates 213 and the side plates 12. Thus, flexibility of the arrangement positions of the first positioning structure 121 and the second positioning structure 211 can be improved by providing the support side plate 213 to facilitate the arrangement of the second positioning structure 211 to be engaged with the first positioning structure 121 at the flange 123. Meanwhile, the mounting support 21 is a frame structure formed by at least connecting the bottom plate 212 and the two support side plates 213, which can improve structural strength of the mounting support 21. Therefore, stability of the mounting of the heating tank component 22, the cooling tank component 23, and the water manifold component 24 at the mounting support 21 can be improved. In this way, stability of the functional module 2 during transportation and the mounting is improved.

According to some embodiments of the present disclosure, the water dispenser 100 further includes a connector. A first positioning structure 121 and a connection hole 124 are formed at the housing 1, and a second positioning structure 211 and an assembling hole 214 are formed at the mounting support 21. The first positioning structure 121 corresponds to the second positioning structure 211 and is engaged with the second positioning structure 211, and the connection hole 124 faces towards the assembling hole 214 and is in communication with the assembling hole 214. The connector passes through the connection hole 124 and the assembling hole 214 that face towards each other. In some embodiments, in a case where the first positioning structure 121 and the second positioning structure 211 are engaged with each other to realize the positioning of the functional module 2 in the housing 1, the connector can better realize the fixed connection between the mounting support 21 and the housing 1 by passing through the connection hole 124 and the assembling hole 214 that face towards each other and are in communication with each other. Thus, stability of the connection between the functional module 2 and the housing 1 can be improved while ensuring the mounting position accuracy of the functional module 2.

The connector may be a fastener for a detachable connection. In an exemplary example, the connector is a threaded fastener with advantages of simple structure and easy assembling, and the mounting support 21 can be tightly connected to the housing 1 by the threaded fastener. In addition, cost can be reduced while ensuring strength of the connection between the mounting support 21 and the housing 1. In another exemplary embodiment of the present disclosure, the threaded fastener may be a screw, a bolt or a stud.

According to some embodiments of the present disclosure, a plurality of first positioning structures 121, a plurality of second positioning structures 211, a plurality of connection holes 124, and a plurality of assembling holes 214 are provided. The plurality of first positioning structures 121 and the plurality of second positioning structures 211 are in one-to-one correspondence, and the plurality of connection holes 124 and the plurality of assembling holes 214 are in one-to-one correspondence. In some embodiments, the mounting support 21 can be positioned at the housing 1 by the respective engagement between the plurality of first positioning structures 121 and the plurality of second positioning structures 211. Therefore, the positioning accuracy of the functional module 2 in the housing 1 can be improved by increasing the positioning position. In addition, a plurality of sets of connection holes 124 and a plurality of sets of assembling holes 214 that are in one-to-one correspondence may be connected by the plurality of connectors, which can better increase the connection position for the mounting support 21 and the housing 1. In this way, it is beneficial to improving the stability of the connection between the functional module 2 and the housing 1.

In a circumferential direction of the housing 1, the plurality of first positioning structures 121 and the plurality of connection holes 124 are distributed at different side surfaces of the housing 1, and the plurality of second positioning structures 211 and the plurality of assembling holes 214 are arranged at different side surfaces of the mounting support 21. In some embodiments, in the circumferential direction of the housing 1, the first positioning structure 121 and the connection hole 124 are formed at each of several side surfaces of the housing 1, and the second positioning structure 211 and the assembling hole 214 are formed at each of the several side surfaces of the mounting support 21. Thus, a plurality of positioning and engagement positions and a plurality of connection positions can be formed in the circumferential direction of the housing 1. Therefore, it is beneficial to improving the positioning accuracy of the functional module 2 in the housing 1 and the stability of the connection between the functional module 2 and the housing 1.

According to some embodiments of the present disclosure, in a horizontal direction, the plurality of first positioning structures 121 and the plurality of connection holes 124 are distributed at two opposite side surfaces of the housing 1, respectively, and the plurality of second positioning structures 211 and the plurality of assembling holes 214 are distributed at two opposite side surfaces of the mounting support 21, respectively. Thus, difficulty in the engagement between the plurality of first positioning structures 121 and the plurality of second positioning structures 211 and difficulty in the engagement between the plurality of connection holes 124 and the plurality of assembling holes 214 can be reduced while ensuring the positioning accuracy of the functional module 2 in the housing 1 and the stability of the connection between the functional module 2 and the housing 1.

According to some embodiments of the present disclosure, a plurality of first positioning structures 121 at the same side and a plurality of second positioning structures 211 at the same side are arranged in the circumferential direction of the housing 1. Therefore, the positioning position for the functional module 2 and the housing 1 can be further increased to improve the positioning accuracy of the functional module 2 in the housing 1. A plurality of connection holes 124 at the same side and a plurality of assembling holes 214 at the same side are arranged in the circumferential direction and/or the up-down direction of the housing 1. Therefore, the connection position for the functional module 2 and the housing 1 can be further increased to improve the stability of the connection between the functional module 2 and the housing 1.

In an exemplary example, each flange 123 is provided with a first positioning structure 121, and has a plurality of connection holes 124 arranged in an up-down direction. The first positioning structure 121 is located at a side of the connection hole 124 away from the body 122. The first positioning structure 121 is a hooking slot formed at an edge of the flange 123 away from the body 122. Each support side plate 213 is provided with a second positioning structure 211, and has a plurality of assembling holes 214 arranged in the up-down direction at a front side and a rear side of the support side plate 213. The second positioning structure 211 is formed as a hook bent downwards and hooked at a bottom edge of the hooking slot.

According to some embodiments of the present disclosure, the water manifold component 24 includes a first water manifold 241 and a second water manifold 242 opposite to each other and spaced apart from each other. A water dispensing basin, a water inlet flow channel, and a water outlet flow channel are formed at the first water manifold 241, and a drainage flow channel is formed at the second water manifold 242. The heating tank component 22 includes a hot tank 221, and the cooling tank component 23 includes a cold tank 231. The hot tank 221 and the cold tank 231 are disposed between the first water manifold 241 and the second water manifold 242. The hot tank 221 and the cold tank 231 are both in communication with the water dispensing basin via the water inlet flow channel. Further, the hot tank 221 and the cold tank 231 are both in communication with the water outlet flow channel and the drainage flow channel. The water dispensing basin may deliver water to each of the hot tank 221 and the cold tank 231 through the water inlet flow channel, and water in the hot tank 221 and the cold tank 231 may be discharged through the water outlet flow channel for users to drink. In some embodiments, the first water manifold 241 can not only supply water to the hot tank 221 and the cold tank 231, but also discharge water in the hot tank 221 and the cold tank 231 for drinking. The water dispensing basin, the water inlet flow channel (for example, a flow channel for supplying water to the hot tank 221 and the cold tank 231), and the water outlet flow channel (for example, a flow channel through which water flows out of the hot tank 221 and the cold tank 231), are all integrated at the first water manifold 241. In this way, the number of components of the water outlet device 243 can be effectively reduced. Therefore, assembling operations of the water outlet device 243 are effectively reduced. In this way, it is beneficial to improving assembling efficiency of the water outlet device 243. In addition, the hot tank 221 and the cold tank 231 are both connected to the drainage flow channel, and therefore residual water in the hot tank 221 and the cold tank 231 can be discharged in time through the drainage flow channel to prevent the residual water from remaining in the hot tank 221 and the cold tank 231 to produce mud or bacteria. In this way, it is beneficial to ensuring cleanliness of the water pathway inside the water outlet device 243.

According to some embodiments of the present disclosure, the first water manifold 241 and the second water manifold 242 are opposite to each other and spaced apart from each other in an up-down direction. The first water manifold 241 is located above the second water manifold 242, and the water dispensing basin is formed at an upper surface of the first water manifold 241. In some embodiments, the hot tank 221 and the cold tank 231 are located below the first water manifold 241, and therefore the hot tank 221 and the cold tank 231 are also located below the water dispensing basin. The water inlet flow channel and the water outlet flow channel are also located below the water dispensing basin and above the hot tank 221 and the cold tank 231, and therefore water in the water dispensing basin may enter the hot tank 221 and the cold tank 231 through the water inlet flow channel due to its own weight. Meanwhile, when the water outlet flow channel is opened. In some embodiments, when the user fetches water, water in the water dispensing basin pushes hot water in the hot tank 221 to be discharged through the water outlet flow channel when the water flows into the hot tank 221, to provide the user with hot water. In addition, water in the water dispensing basin pushes cold water in the cold tank 231 to be discharged through the water outlet flow channel when the water flows into the cold tank 231, to provide the user with cold water. In some embodiments, water can flow into or out of each of the heating tank component 22 and the cooling tank component 23 without delivering by a pump, which is simple in structure and has low cost. In addition, the second water manifold 242 is located below the hot tank 221 and the cold tank 231. Therefore, when the drainage flow channel is opened, water in the heating tank component 22 and the cooling tank component 23 may enter the drainage flow channel due to its own weight, which is simple in structure and has low cost.

According to some embodiments of the present disclosure, the electronic control component includes an electric control box 251 and an electric control switch 252. The electric control box 251 is disposed at a side of the first water manifold 241 away from the second water manifold 242. In some embodiments, the electric control box 251 is located at a side of the first water manifold 241 away from the heating tank component 22 and the cooling tank component 23. As a result, the electric control box 251, the hot tank 221, and the cold tank 231 can fully utilize a space between the two opposite sides of the first water manifold 241. meanwhile, maintenance operations such as overhauling of the electric control box 251 is facilitated. The electric control switch 252 is disposed between the first water manifold 241 and the second water manifold 242. In some embodiments, the electric control switch 252, the hot tank 221, and the cold tank 231 are all disposed between the first water manifold 241 and the second water manifold 242. Thus, a distance between the electric control switch 252 and the hot tank 221 and a distance between the electric control switch 252 and the cold tank 231 can be shortened. It can be understood that the hot tank 221 is provided with a heating unit, and the cold tank 231 is provided with a refrigeration unit. Therefore, a distance between the electric control switch 252 and the heating unit and a distance between the electric control switch 252 and the refrigeration unit can be shortened. In this way, it is convenient for routing of a wiring harness for connecting the electric control switch 252 with the heating unit and the refrigeration unit. Meanwhile, a length of the wiring harness for connecting the electric control switch 252 with the heating unit and the refrigeration unit can be shortened. In an exemplary example, two electric control switches 252 are provided. The two electric control switches 252 are electrically connected to the heating unit and the refrigeration unit, respectively, to independently control the heating unit and the refrigeration unit.

According to some embodiments of the present disclosure, the electric control box 251 is located at an outer peripheral side of the water dispensing basin at a side of the water dispensing basin radially away from the heating tank component 22. Therefore, a distance between the hot tank 221 and the electric control box 251 can be better increased. Thus, an impact of a high temperature at the hot tank 221 on the electric control box 251 is reduced. In this way, reliability of the electric control box 251 is improved. The electric control switch 252 is disposed at an outer side surface of the mounting support 21, which allows the electric control switch 252 to be intuitively exposed to the user. In this way, it is convenient for user's operation.

In an exemplary example, the functional module 2 includes a mounting support 21, a heating tank component 22, a cooling tank component 23, a water manifold component 24, and an electronic control component. The mounting support 21 includes a bottom plate 212 and two support side plates 213, and the two support side plates 213 are disposed at a left end and a right end of the bottom plate 212 and spaced apart from each other in a left-right direction. The heating tank component 22, the cooling tank component 23, the water manifold component 24, and the electronic control component are located above the bottom plate 212 between the two support side plates 213. The water manifold component 24 includes a first water manifold 241 and a second water manifold 242 opposite to each other and spaced apart from each other in an up-down direction. The first water manifold 241 is located above the second water manifold 242. A water dispensing basin is formed at an upper surface of the first water manifold 241. A water inlet flow channel and a water outlet flow channel are formed in the first water manifold 241, and the water inlet flow channel and the water outlet flow channel are located below the water dispensing basin and in communication with the water dispensing basin. A drainage flow channel is formed at the second water manifold 242. In addition, the water manifold component 24 includes a water outlet device 243 and a fixing cover 244. The water outlet device 243 is disposed at the first water manifold 241. The water outlet flow channel is in communication with the tap 142 via the water outlet device 243. The fixing cover 244 is configured to fix the water outlet device 243 on the first water manifold 241.

The heating tank component 22 includes a hot tank 221 and a three-way tube 222 that are located between the first water manifold 241 and the second water manifold 242. Three outlets of the three-way tube 222 are in communication with the water inlet flow channel, the drainage flow channel, and a water inlet of the hot tank 221, respectively. A water outlet of the hot tank 221 is in communication with the water outlet flow channel. A heating element is provided in the hot tank 221.

The cooling tank component 23 includes a cold tank 231, a condenser 232, a compressor 233, and an evaporator. The cold tank 231 and the compressor 233 are located between the first water manifold 241 and the second water manifold 242. The cold tank 231 and the hot tank 221 are arranged in a horizontal direction. The cold tank 231 has a water inlet in communication with the water inlet flow channel, a water outlet in communication with the water outlet flow channel, and a drainage outlet in communication with the drainage flow channel. The condenser 232 is disposed at a back side of the water manifold component 24. The compressor is located directly below the hot tank 221 at an outer peripheral side of the cold tank 231, and the evaporator is located in the cold tank 231. Therefore, water in the cold tank 231 is cooled through cooperation among the condenser 232, the compressor 233, and the evaporator.

A water dispenser 100 according to exemplary embodiments of the present disclosure will be described below with reference to FIGS. 1 to 17. It should be understood that the following description is illustrative only, and is intended to explain, rather than limiting the present disclosure.

### First Embodiment

As shown in FIGS. 9 to 11, a water dispenser 100 according to the first embodiment is a tabletop water dispenser 100. A housing 1 includes a base 11, two side plates 12 opposite to each other and spaced apart from each other in a left-right direction, an upper cover 13, a front cover component 14, and an intelligent seat 17. Lower ends of the two side plates 12 are connected to the base 11, and upper ends of the two side plates 12 are connected to the upper cover 13. An insertion hole in communication with the water dispensing basin is formed in the upper cover 13, and the intelligent seat 17 is disposed in the insertion hole. A function module 2 is located between the two side plates 12 and between the base 11 and the upper cover 13. A left end and a right end of the front cover component 14 are connected to the two side plates 12, respectively, and are located directly in front of the function module 2. The front cover component 14 includes a front cover plate 141, and a tap 142 and a water receiving box 143 that are disposed at the front cover plate 141. The front cover component 14 includes a plurality of taps 142 in the left-right direction, and the water receiving box 143 is located below the plurality of taps 142.

### Second Embodiment

The second embodiment 2 has configurations substantially same as the configurations of the first embodiment 1, in which same components are denoted with same reference numerals. As shown in FIGS. 1 to 9. The second embodiment differs from the first embodiment 1 in that a receiving chamber 10c located below the mounting chamber 10a is also formed in the housing 1, and a partition 18 is provided in the receiving chamber 10c to divide the receiving chamber 10c into an upper receiving space and a lower receiving space. The housing 1 further includes a back plate 15 and a door 16. A left end and a right end of the back plate 15 are connected to rear ends of the two side plates 12 and are located at a back side of the receiving chamber 10c. The door 16 is openably disposed at one of the two side plates 12 and is located at a front side of the receiving chamber 10c, and the door 16 is configured to expose or cover the receiving chamber 10c.

### Third Embodiment

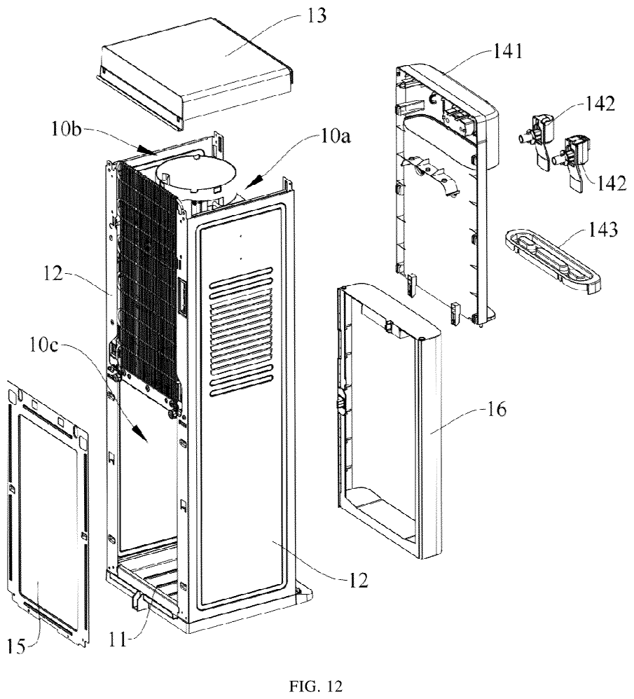

The third embodiment has configurations substantially same as the configurations of the first embodiment, in which same components are denoted by same reference numerals. As shown in FIGS. 12 to 17, the third embodiment differs from the first embodiment in that a water dispenser 100 according to the third embodiment is a bottom-loaded water dispenser 100. A receiving chamber 10c located below the mounting chamber 10a is formed in the housing 1. The receiving chamber 10c is configured to receive a water bucket. No insertion hole is formed at the upper cover 13. The housing 1 further includes a back plate 15 and a door 16. A left end and a right end of the back plate 15 are connected to rear ends of two side plates 12, respectively, and are located at a back side of the receiving chamber 10c. The door 16 is openably arranged at one of the two side plates 12 and is located at a front side of the receiving chamber 10c, and the door 16 is configured to expose or cover the receiving chamber 10c.

A water dispenser 100 according to embodiments of the present disclosure will be described below with reference to the accompanying drawings.

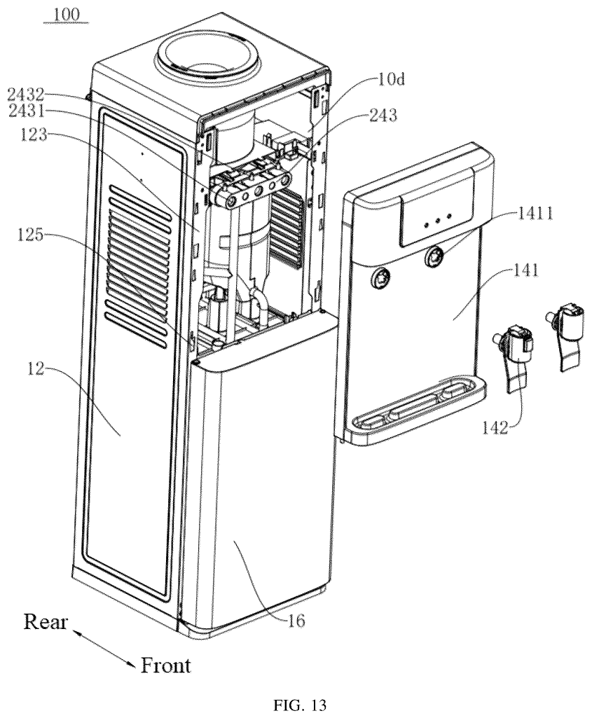

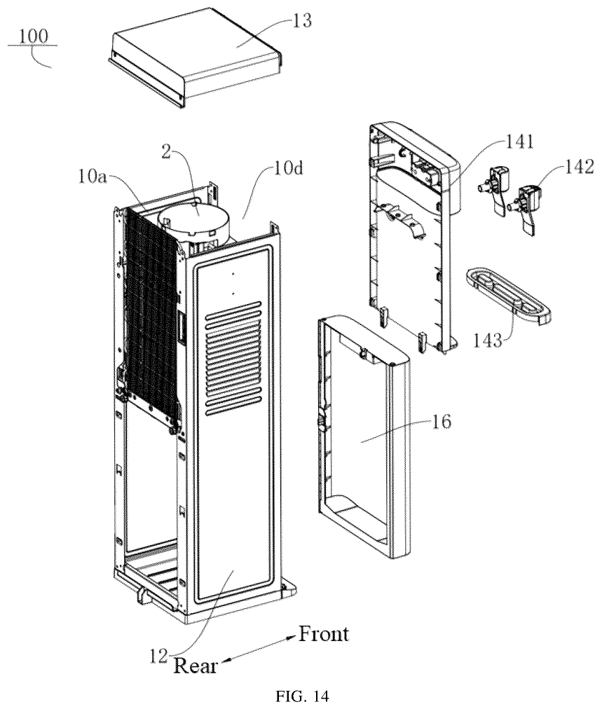

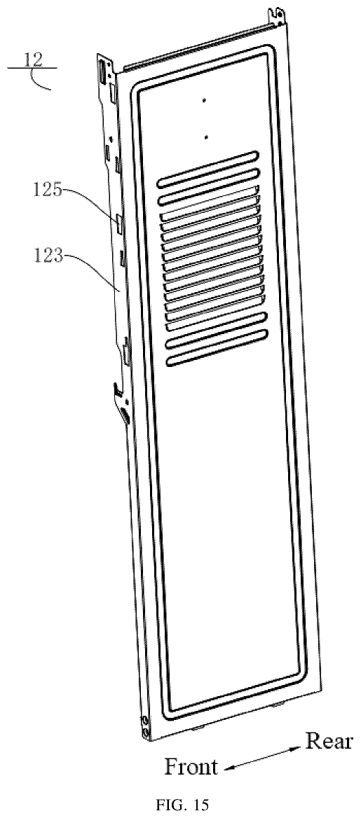

As shown in FIGS. 13 and 14, the water dispenser 100 according to the embodiments the present disclosure includes a housing 1, a water outlet device 243, and a tap 142.

The housing 1 has a front opening 10d. Further, the housing 1 includes a front cover plate 141 detachably disposed at the front opening 10d to cover the front opening 10d. The water outlet device 243 is at least partially disposed in the housing 1 and faces towards the front opening 10d. The water outlet device 243 may be mounted into the housing 1 through the front opening 10d of the housing 1, and an assembling of the water outlet device 243 is relatively simple.

The water outlet device 243 has a water supply opening 2431, and waterflow in the water dispenser 100 may flow out from the water supply opening 2431. The water outlet device 243 is provided with a guide post 2432 at an upper surface of the water outlet device 243. The guide post 2432 extends in an up-down direction. After the water outlet device 243 is mounted within the housing 1, a position of the water outlet device 243 is limited inside the housing 1 by the front cover plate 141, which can protect the water outlet device 243 during transportation of the water dispenser 100 and prevent the water outlet device 243 from being damaged by an external force impact. The front cover plate 141 has an avoidance opening 1411 and a guide hole 1412. The avoidance opening 1411 faces towards the water supply opening 2431 and is in communication with the water supply opening 2431, and the guide post 2432 is engaged into the guide hole 1412. After the guide post 2432 is engaged into the guide hole 1412 in place, the avoidance opening 1411 may be concentric with the water supply opening 2431, which can ensure an effect of concentricity between the avoidance opening 1411 and the water supply opening 2431.

A part of the tap 142 is located at a front side of the front cover plate 141 and extends into the avoidance opening 1411 to be connected to the water supply opening 2431. Since the avoidance opening 1411 and the water supply opening 2431 are concentric, the tap 142, the avoidance opening 1411, and the water supply opening 2431 are all concentric after the tap 142 extends into the avoidance opening 1411. As a result, the part of the tap 142 extending into the avoidance opening 1411 can be better engaged into the water supply opening 2431. In this way, a risk of water leakage of the tap 142 is reduced.

In the water dispenser 100 according to the embodiments of the present disclosure, after the guide post 2432 is engaged into the guide hole 1412 in place, the avoidance opening 1411 and the water supply opening 2431 are brought to be concentric, which can ensure the concentricity between the avoidance opening 1411 and the water supply opening 2431. Moreover, since the part of the tap 142 extends into the avoidance opening 1411 of the front cover plate 141 to be connected to the water supply opening 2431 of the water outlet device 243, the tap 142, the avoidance opening 1411, and the water supply opening 2431 are all concentric after the tap 142 extends into the avoidance opening 1411. Therefore, the part of the tap 142 extending into the avoidance opening 1411 can be better engaged into the water supply opening 2431. In this way, the risk of the water leakage of the tap 142 is reduced.

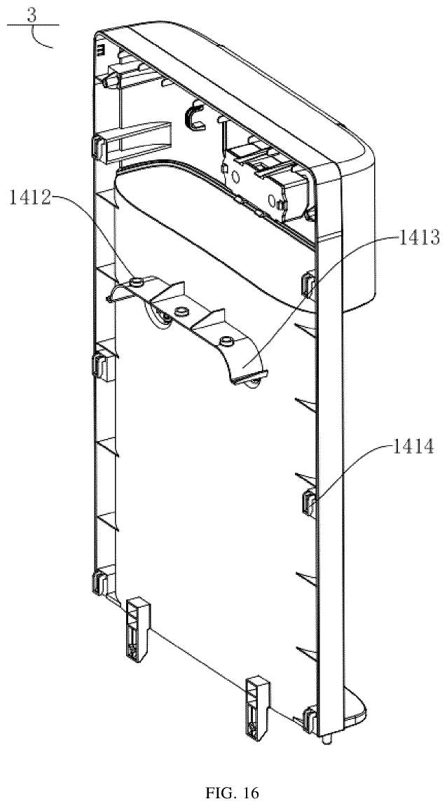

According to some embodiments of the present disclosure, as shown in FIGS. 13 and 16, the front cover plate 141 is provided with a guide plate 1413 at a side of the front cover plate 141 facing towards the water outlet device 243, and the guide hole 1412 is formed at the guide plate 1413 and extends through the guide plate 1413 in the up-down direction. It can be understood that the guide hole 1412 is formed at a position corresponding to the guide post 2432, and therefore the guide hole 1412 is easily formed at the guide plate 1413 by providing the guide plate 1413 at this position. In this way, reliability of a position of engagement between the guide post 2432 and the guide hole 1412 can be increased. After the guide post 2432 is engaged into the guide hole 1412 in place, the avoidance opening 1411 and the water supply opening 2431 are brought to be concentric, which can ensure the concentricity between the avoidance opening 1411 and the water supply opening 2431. Therefore, the part of the tap 142 extending into the avoidance opening 1411 can be better engaged into the water supply opening 2431. In this way, the risk of the water leakage of the tap 142 is reduced.

According to some embodiments of the present disclosure, as shown in FIGS. 13 and 15, the housing 1 includes two side plates 12 located at two sides of the water dispenser 100 in a left-right direction of the water dispenser 100. The water outlet device 243 is disposed between the two side plates 12, the front opening 10d is located between the two side plates 12, and the front cover plate 141 is detachably connected to the two side plates 12. The housing 1 may be detached into a plurality of components, and the two side plates 12 are engaged with and connected to the front cover plate 141, which can achieve structural stability of the water dispenser 100 and facilitate assembling and disassembling of the water dispenser 100. Meanwhile, the side plates 12 and the front cover plate 141 can realize a sealing effect to prevent dust, moisture or other foreign materials s from entering an interior of the water dispenser 100.

In other exemplary embodiments of the present disclosure, the present disclosure is not limited thereto, and the side plates 12 may have structures such as ventilation holes, heat sinks or fans to achieve a heat dissipation function of the water dispenser 100.

Further, as shown in FIGS. 13 and 15, the two side plates are each provided with a flange 123 at a front end of each of the two side plates 12. In this way, edge strength of the front ends of the two side plates 12 can be increased, allowing the side plates 12 to be more durable. The two flanges 123 extend toward each other, and each of the two flanges 123 has a positioning hole 125. The front cover plate 141 is provided with a connection hook 1414 engaged into the positioning hole 125. During the assembling of the water dispenser 100, the connection hook 1414 at the front cover plate 141 extends into the positioning hole 125. When the front cover plate 141 moves downwards, the guide post 2432 is engaged into the guide hole 1412, and the connection hook 1414 reaches a bottom end of the positioning hole 125, to bring the avoidance opening 1411 of the front cover plate 141 to be concentric with the water supply opening 2431 of the water outlet device 243. Therefore, the part of the tap 142 extending into the avoidance opening 1411 can be better engaged into the water supply opening 2431. In this way, the risk of the water leakage of the tap 142 is reduced.

According to some embodiments of the present disclosure, as shown in FIG. 13, the water outlet device 243 has a plurality of guide posts 2432 arranged at intervals, and the plurality of guide holes 1412 and the plurality of guide posts 2432 are in one-to-one correspondence. The plurality of guide posts 2432 are engaged into the plurality of guide holes 1412, respectively. As a result, reliability of concentricity between the avoidance opening 1411 of the front cover plate 141 and the water supply opening 2431 of the water outlet device 243 can be improved. Therefore, the part of the tap 142 extending into the avoidance opening 1411 can be better engaged into the water supply opening 2431. In this way, the risk of the water leakage of the tap 142 is reduced.

According to some embodiments of the present disclosure, the guide post 2432 is provided with a guide portion at an upper section of the guide post 2432, and a cross-sectional area of the guide portion gradually decreases from bottom to top. It can be understood that during the engagement between the guide post 2432 and the guide hole 1412, a part of the guide post 2432 with a smaller cross-sectional area first enters the guide hole 1412, and a cross-sectional area of a part of the guide post 2432 engaged into the guide hole 1412 gradually increases. In this case, the guide post 2432 is gradually engaged into the guide hole 1412 in place. As a result, the reliability of the concentricity between the avoidance opening 1411 of the front cover plate 141 and the water supply opening 2431 of the water outlet device 243 can be improved. Therefore, the part of the tap 142 extending into the avoidance opening 1411 can be better engaged into the water supply opening 2431. In this way, the risk of the water leakage of the tap 142 is reduced.

In this embodiment, a diameter of a maximum cross-section of the guide post 2432 is 5.5 mm, and a diameter of the guide hole 1412 is 6.5 mm. as a result, a fit clearance between the guide post 2432 and the guide hole 1412 is small, and therefore the guide post 2432 is better engaged into the guide hole 1412. Moreover, the guide post 2432 has a guide C angle at upper end of the guide post 2432, and the guide hole 1412 thus easily extends into the guide post 2432.

According to some embodiments of the present disclosure, as shown in FIGS. 13 and 14, the water outlet device 243 has a plurality of water supply openings 2431, the water dispenser 100 includes a plurality of taps 142, and the front cover plate 141 has a plurality of avoidance openings 1411. The plurality of avoidance openings 1411 and the plurality of water supply openings 2431 are in one-to-one correspondence. Water of different temperatures may flow through the plurality of taps 142, respectively. For example, three water supply openings 2431 and a plurality of avoidance openings 1411 are provided, and the plurality of taps 142 include a room temperature tap 142, a hot water tap 142, or a cold water tap 142. In this way, the water dispenser 100 has functions of providing room temperature water, hot water, and cold water.

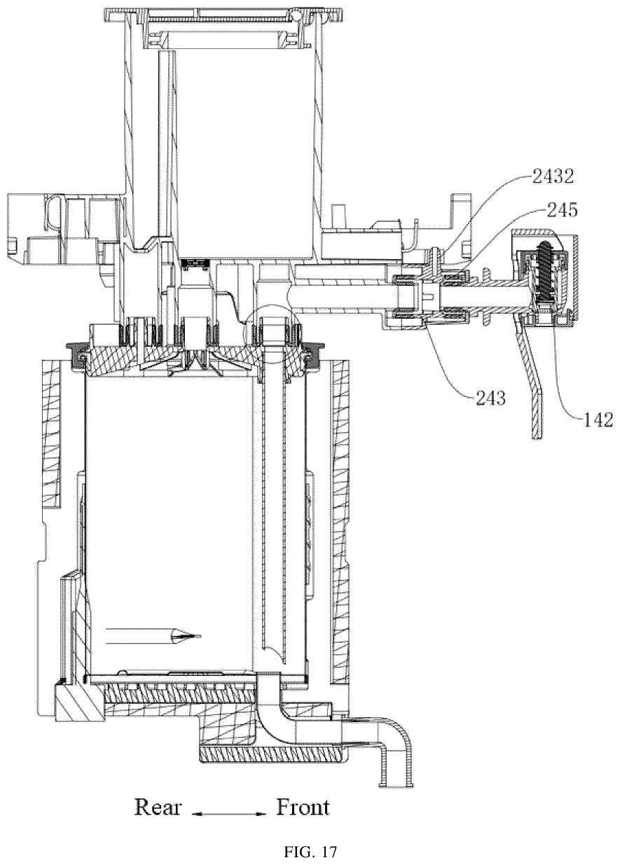

According to some embodiments of the present disclosure, as shown in FIGS. 13 and 17, a seal 245 is provided between the water supply opening 2431 and the tap 142. The seal 245 can realize sealing between the water outlet device 243 and the tap 142, ensure an effect of the sealing between the water outlet device 243 and the tap 142, and reduce the risk of the water leakage of the tap 142.

Further, the water supply opening 2431 and the tap 142 are connected to each other through insertion. The seal 245 is of a ring shape, and the seal has a mounting groove formed at an end face of an end of the seal 245 in an axial direction of the seal 245. The mounting groove extends into a ring shape in a circumferential direction of the seal 245. An end of the water supply opening 2431 connected to the tap 142 or an end of the tap 142 connected to the water supply opening 2431 is inserted into the mounting groove. The seal 245 is partially located between the tap 142 and the water supply opening 2431. As a result, a connection between the tap 142 and the water supply opening 2431 can be sealed in both a radial direction and an axial direction to ensure the sealing between the water outlet device 243 and the tap 142. Further, the mounting groove can limit a position of the tap 142 or a position of the water outlet device 243 inserted therein, which increases reliability of the assembling position of the water outlet device 243 and the tap 142.

Further, a single-side compression amount of the seal 245 between the tap 142 and the water supply opening 2431 in a radial direction of the water supply opening 2431 is greater than or equal to 15% and smaller than or equal to 20%. A service life of the seal 245 can be extended and the water outlet device 243 and the tap 142 can be quickly disassembled or assembled with each other, while meeting sealing performance requirements. In another exemplary embodiment of the present disclosure, the water supply opening 2431 may be connected to an outer side of a peripheral wall of the tap 142 through insertion, and the seal 245 may be at least partially disposed at an outer side of a peripheral wall of the water supply opening 2431 to seal a gap between the water outlet device 243 and the tap 142 and provide a contact pressure for the connection between the water outlet device 243 and the tap 142. In this way, the water outlet device 243 and the tap 142 are quickly disassembled or assembled with each other.

The single-side compression amount of the seal 245 in the radial direction of the tap 142 may be 15%, 16%, 17%, 18%, 19%, or 20%, etc.

A water dispenser 100 according to an exemplary embodiment of the present application will be described below with reference to the accompanying drawings. It should be understood that the following description is illustrative only, and is intended to explain rather than limiting the present disclosure.

The water dispenser 100 according to the present disclosure, as shown in FIGS. 13 and 14, includes a housing 1 and a water outlet device 243.

The housing 1 has a front opening 10d. Further, the housing 1 includes two side plates 12 located at two sides of the water dispenser 100 in a left-right direction of the water dispenser 100. The water outlet device 243 is disposed between the two side plates 12, the front opening 10d is located between the two side plates 12, and the front cover plate 141 is detachably connected to the two side plates 12. The front cover plate 141 has an avoidance opening 1411 and a guide hole 1412. The avoidance opening 1411 faces towards the water supply opening 2431 and is in communication with the water supply opening 2431, and the guide post 2432 is engaged into the guide hole 1412. The front cover plate 141 is provided with a guide plate 1413 at a side of the front cover plate 141 facing towards the water outlet device 243, and the guide hole 1412 is formed at the guide plate 1413 and extends through the guide plate 1413 in the up-down direction. Flanges 123 are provided at front ends of the two side plates 12, respectively, and the two flanges 123 extend towards each other. The flange 123 has a positioning hole 125, and the front cover plate 141 is provided with a connection hook 1414 engaged into the positioning hole 125.

The water outlet device 243 is at least partially disposed in the housing 1 and faces towards the front opening 10d. The water outlet device 243 has a water supply opening 2431. Further, the water outlet device 243 is provided with a plurality of guide posts 2432 arranged at intervals at an upper surface of the water outlet device 243, and the guide post 2432 extends in an up-down direction. The front cover plate 141 has a plurality of guide posts 2432 in one-to-one correspondence with the plurality of guide posts 2432. Each of the plurality of guide post 2432 is provided with a guide portion at an upper section of the guide post 2432, and a cross-sectional area of the guide portion gradually decreases from bottom to top.

A part of a tap 142 is located at a front side of the front cover plate 142, and extends into the avoidance opening 1411 to be connected to the water supply opening 2431. Three water supply openings 2431 and a plurality of avoidance openings 1411 are provided. The tap 142 includes a room temperature water tap 142, a hot water tap 142, or a cold water tap 142. In this way, the water dispenser 100 has functions of providing room temperature water, hot water, and cold water. A seal 245 is provided between the water supply opening 2431 and the tap 142. The water supply opening 2431 and the tap 142 are connected to each other through insertion. The seal 245 is of a ring shape. Further, the seal 245 has a mounting groove formed at an end face of an end of the seal 245 in an axial direction of the seal 245. The mounting groove extends into a ring shape in a circumferential direction of the seal 245. An end of the water supply opening 2431 connected to the tap 142 or an end of the tap 142 connected to the water supply opening 2431 is inserted into the mounting groove. The seal 245 is partially located between the tap 142 and the water supply opening 2431. A single-side compression amount of the seal 245 between the tap 142 and the water supply opening 2431 in a radial direction of the water supply opening 2431 is 20%.

The water dispenser 100 further includes a connection device and a first water manifold 241, and the connection device is a cooling tank component 23 or a heating tank component 22. When the connection device is the cooling tank component 23, the cooling tank component 23 can cool waterflow flowing through the cooling tank component 23. When the connection device is the heating tank component 22, the heating tank component 22 can heat waterflow flowing through the heating tank component 22. In this way, user's different demands for the hot water, the cold water, and warm water can be satisfied.

A flow channel is formed at the first water manifold 241. The flow channel includes a first flow passageway and a second flow passageway. The first flow passageway has a first inlet and a first outlet, and the second flow passageway has a second inlet and a second outlet. The first inlet and the second inlet are configured as water source ports. The second outlet is configured to supply water to the connection device for water treatment, and the first outlet is configured to be connected to the water outlet device 243 and delivery water from the water source out of the water dispenser 100. In this way, the first water manifold 241 is integrated with the first flow passageway and the second flow passageway, which can improve the integration and the reliability of the water dispenser 100.

The first inlet of the first flow passageway may be connected to a water source, and the first outlet of the first flow passageway may be connected to the water outlet device 243. In some embodiments, waterflow from the water source may sequentially flow through the first inlet, the first flow passageway, and the first outlet, and then flow towards the water outlet device 243, and the waterflow is discharged out of the water dispenser 100 by means of the tap 142 to realize water outflowing of the water dispenser 100. The second inlet of the second flow passageway may be connected to the water source, and the second outlet of the second flow passageway may be connected to the connection device for the water treatment. In some embodiments, the waterflow from the water source may sequentially flow through the second inlet, the second flow passageway, and the second outlet, and then flow towards the connection device for the water treatment, and the waterflow is treated by the connection device for the water treatment. In addition, the connection device for the water treatment may be the heating tank component 22, which heats the waterflow flowing through the hot tank.

The second inlet is in communication with the first flow passageway, which can further improve the integration of the water dispenser 100. It can be understood that when the waterflow flows through the first flow passageway, a part of the waterflow may continue to flow along the first flow passageway and then flow towards the water outlet device 243, and another part of the water flow may flow towards the second flow passageway and then flow towards the connection device for the water treatment. In some embodiments, by integrating the second flow passageway into the first flow passageway, the integration of the water dispenser 100 is improved.

In other embodiments of the present disclosure, according to actual conditions, the first flow passageway and the second flow passageway may also be two independent flow passageways.

The flow channel may further include a third flow passageway. The third flow passageway has a third inlet and a third outlet. The third inlet is configured as a first pipe port for receive the water treated by the connection device for the water treatment, and the third outlet is connected to the water outlet device 243 and is configured to deliver the water treated by the connection device for the water treatment out of the water dispenser 100. In this way, the first water manifold 241 is integrated with the third flow passageway to further improve the integration and the reliability of the water dispenser 100.

An operation principle of the water dispenser 100 will be described below.

For the room temperature water outflowing of the water dispenser 100, waterflow of a room temperature in the water dispensing basin may sequentially flow through the first inlet, the first flow passageway, and the first outlet, and finally flow towards the room temperature water tap 142 to achieve the room temperature water outflowing.

For the hot water outflowing of the water dispenser 100, the waterflow of the room temperature water in the water dispensing basin may sequentially flow through the second inlet, the second flow passageway, and the second outlet into the heating tank component, and then is heated by the heating tank component. Thereafter, the waterflow may sequentially flow through the third inlet, the third flow passageway, and the third outlet, and finally flow towards the hot water tap 142 to achieve the hot water outflowing.

For the cold water outflowing of the water dispenser 100, the waterflow of the room temperature in the water dispensing basin may sequentially flow through a fourth inlet, a fourth flow passageway, and a fourth outlet into the cooling tank component, and then refrigerated by the cooling tank component. Thereafter, the waterflow may sequentially flow through a fifth inlet, a fifth flow passageway, and a fifth outlet, and finally flow towards the cold water tap 142 to achieve the cold water outflowing.

In the present disclosure, unless specified or limited otherwise, the terms “mounted,” “connected,” “coupled” and “fixed” are understood broadly, such as fixed, detachable mountings, connections and couplings or integrated, and may be direct and via media indirect mountings, connections, and couplings, and also may be inner mountings, connections and couplings of two components or interaction relations between two components. For those skilled in the art, the specific meaning of the above-mentioned terms in the embodiments of the present disclosure can be understood according to specific circumstances.

Reference throughout this specification to “an embodiment”, “some embodiments”, “an example”, “a specific example”, or “some examples” means that a particular feature, structure, material, or characteristic described in connection with the embodiment or example is included in at least one embodiment or example of the present disclosure. The appearances of the above phrases in various places throughout this specification are not necessarily referring to the same embodiment or example of the present disclosure. Furthermore, the particular features, structures, materials, or characteristics may be combined in any suitable manner in one or more embodiments or examples. In addition, different embodiments or examples and features of different embodiments or examples described in the specification may be combined by those skilled in the art without mutual contradiction.

Although the embodiments of the present disclosure have been shown and described, those of ordinary skilled in the art can understand that various changes, modifications, substitutions and variations can be made to these embodiments without departing from the principles and purpose of the present disclosure, and the scope of the present disclosure is defined by the claims and their equivalents.

What is claimed is:

1. A water dispenser comprising:
a housing; and
a functional module disposed in the housing, the functional module comprising a mounting support, a heating tank component, a cooling tank component, a water manifold component, and an electronic control component, the heating tank component, the cooling tank component, the water manifold component, and the electronic control component being disposed at the mounting support.

2. The water dispenser according to claim 1, wherein the mounting support is detachably connected to the housing.

3. The water dispenser according to claim 1, wherein the housing has a mounting chamber for receiving the functional module, wherein the mounting chamber has a mounting opening upwards, and the functional module being adapted to be placed in the mounting chamber through the mounting opening.

4. The water dispenser according to claim 3, wherein the housing comprises a support frame, the functional module being disposed at the support frame, wherein:
the support frame comprises:
a base located at a lower side of the mounting chamber; and
two side plates opposite to each other and spaced apart from each other in a left-right direction, the two side plates being located at a left side and a right side of the mounting chamber, respectively, lower ends of the two side plates being connected to the base, and the mounting opening being defined between upper ends of the two side plates; and
the support frame has an assembled state in which a distance between the two side plates increases from bottom to top.

5. The water dispenser according to claim 4, wherein in the assembled state, an angle of the two side plates relative to an up-down direction ranges from 10° to 20°.

6. The water dispenser according to claim 3, wherein:
a first positioning structure is formed at the housing; and
a second positioning structure is formed at the mounting support,
wherein the first positioning structure is engaged with the second positioning structure when placing the functional module into the mounting chamber from top to bottom to limit a position of the functional module; and
wherein the first positioning structure is disengaged from the second positioning structure when moving the functional module relative to the housing from bottom to top.

7. The water dispenser according to claim 6, wherein:
one of the first positioning structure and the second positioning structure is formed as a hooking slot; and
another one of the first positioning structure and the second positioning structure is formed as a hook.

8. The water dispenser according to claim 6, wherein the housing comprises two side plates opposite to each other in a left-right direction, wherein:
the two side plates are located at two opposite sides of the mounting chamber, respectively; and
each of the two side plates comprises a body and two flanges respectively disposed at a front end and a rear end of the body, the mounting support being located between the two flanges of the two side plates, the two flanges of one of the two side plates being bent and extending towards the two flanges of another one of the two side plates, and the first positioning structure being disposed at each of the two flanges.

9. The water dispenser according to claim 8, wherein the mounting support comprises:
a bottom plate; and
two support side plates disposed at a left side and a right side of the bottom plate, respectively, each of the two support side plates being located between the two flanges at a same side as the support side plate, and the second positioning structure being disposed at each of front sides and rear sides of the two support side plates.

10. The water dispenser according to claim 1, further comprising a connector, wherein:
a first positioning structure and a connection hole are formed at the housing; and
a second positioning structure and an assembling hole are formed at the mounting support, wherein:
the first positioning structure corresponds to the second positioning structure and is engaged with the second positioning structure;
the connection hole faces towards the assembling hole and is in communication with the assembling hole; and
the connector passes through the connection hole and the assembling hole that face towards each other.

11. The water dispenser according to claim 10, wherein a plurality of first positioning structures, a plurality of second positioning structures, a plurality of connection holes, and a plurality of assembling holes are provided, wherein:
the plurality of first positioning structures and the plurality of second positioning structures are in one-to-one correspondence;
the plurality of connection holes and the plurality of assembling holes are in one-to-one correspondence; and
in a circumferential direction of the housing, the plurality first positioning structures and the plurality of connection holes are distributed at different sides surfaces of the housing, and the plurality of second positioning structures and the plurality of assembling holes are distributed at different sides surfaces of the mounting support.

12. The water dispenser according to claim 1, wherein:
the water manifold component comprises a first water manifold and a second water manifold opposite to each other and spaced apart from each other, a water dispensing basin, a water inlet flow channel, and a water outlet flow channel being formed at the first water manifold, and a drainage flow channel being formed at the second water manifold;
the heating tank component comprises a hot tank; and
the cooling tank component comprises a cold tank, the hot tank and the cold tank being disposed between the first water manifold and the second water manifold, the hot tank and the cold tank being both in communication with the water dispensing basin via the water inlet flow channel and both in communication with the water outlet flow channel and the drainage flow channel.

13. The water dispenser according to claim 12, wherein:
the first water manifold and the second water manifold are opposite to each other and spaced apart from each other in an up-down direction;
the first water manifold is located above the second water manifold; and
the water dispensing basin is formed at an upper surface of the first water manifold.

14. The water dispenser according to claim 12, wherein the electronic control component comprises:
an electronic control box disposed at a side of the first water manifold away from the second water manifold; and
an electronic control switch disposed between the first water manifold and the second water manifold.

15. The water dispenser according to claim 14, wherein:
the electronic control box is located at an outer peripheral side of the water dispensing basin at a side of the water dispensing basin radially away from the hot tank; and
the electronic control switch is disposed at an outer side surface of the mounting support.

16. A water dispenser comprising:
a housing having a front opening and comprising a front cover plate, the front cover plate being detachably disposed at the front opening to cover the front opening;
a water outlet device at least partially disposed in the housing and facing towards the front opening, wherein the water outlet device has a water supply opening and a guide post, the guide post being provided at an upper surface of the water outlet device, the guide post extending in an up-down direction, and wherein the front cover plate has an avoidance opening and a guide hole, the avoidance opening facing towards the water supply opening and being in communication with the water supply opening, and the guide post being engaged into the guide hole; and
a tap, a part of the tap being located at a front side of the front cover plate and extending into the avoidance opening to be connected to the water supply opening.

17. The water dispenser according to claim 16, wherein the front cover plate is provided with a guide plate at a side of the front cover plate facing towards the water outlet device, the guide hole being formed at the guide plate and extending through the guide plate in the up-down direction.

18. The water dispenser according to claim 16, wherein the housing comprises two side plates located at two sides of the water dispenser in a left-right direction of the water dispenser, the water outlet device being disposed between the two side plates, the front opening being located between the two side plates, and the front cover plate being detachably connected to the two side plates.

19. The water dispenser according to claim 18, wherein:
the two side plates are each provided with a flange at a front end of each of the two side plates, the two flanges extending towards each other, and the flange having a positioning hole; and
the front cover plate is provided with a connection hook engaged into the positioning hole.

20. The water dispenser according to claim 16, wherein:
the water outlet device has a plurality of guide posts arranged at intervals; and
the front cover plate has a plurality of guide holes, the plurality of guide holes and the plurality of guide posts being in one-to-one correspondence.
